(19) United States
(12) Patent Application Publication
(10) Pub. No.: US 2014/0315084 A1
(43) Pub. Date: Oct. 23, 2014

(54) METHOD AND APPARATUS FOR ENERGY STORAGE

(71) Applicant: NOKIA CORPORATION, Espoo (FI)

(72) Inventors: Yinglin LIU, Cambridge (GB); Mark Allen, Cambridge (GB); Piers Andrew, Cambridge (GB)

(73) Assignee: Nokia Corporation, Espoo (FI)

(21) Appl. No.: 13/865,522

(22) Filed: Apr. 18, 2013

(51) Int. Cl. H01M 4/62; H01G 11/46; H01M 10/058; H01M 10/0525; H01M 4/13; H01M 4/66; H01G 11/36; H01G 11/68

(52) U.S. Cl. CPC H01M 4/624; H01G 11/36; H01G 11/46; H01G 11/68; H01M 10/0525; H01M 4/13; H01M 4/661; H01M 10/058
USPC 429/219; 361/502; 429/233; 429/231.8; 429/218.1; 429/245; 156/182; 429/232

(57) ABSTRACT

In accordance with an example embodiment of the present invention, apparatus is provided comprising first and second electrodes, first and second current collectors, an electrolyte, and a first contact layer; wherein the electrolyte is configured to separate the first and second electrodes; and wherein the first contact layer is configured to form an electrical contact between the first current collector and the first electrode.

### TECHNICAL FIELD

The present application relates generally to method and apparatus for energy storage using a battery or supercapacitor.

### BACKGROUND

There is increasing interest in printable energy storage devices, such as supercapacitor and batteries due to their low cost and mechanical flexibility. For any kind of energy storage device, either traditional or printable device, it is of great importance to minimize the internal resistance, as the power delivery of the device depends largely on the equivalent series resistance (ESR). Any reduction in ESR will yield immediate power delivery improvements. Low ESR is particular important for a supercapacitor, since it is mainly for high current application. The interfacial resistance between the electrode and the current collector contributes a significant part of the overall ESR of the supercapacitor. For a printable energy storage device, procedures to reduce interfacial resistance should be compatible with printing technology.

Aluminum foil is commonly used as the current collectors for supercapacitors, and for batteries aluminium is typically used for the cathode current collector, and copper foil for the anode current collector, however, interfacial resistance, with the electrode, can present a problem for both these metals. Aluminium and copper foil has a surface that is smooth and the contact area between the electrode and foil is limited, also adhesion to between an electrode, and the aluminium surface, is often poor. Further, aluminium and copper readily form an insulating oxide layer, which increases the interfacial resistance. Surface etching and other procedures can be used to enlarge contact area, for aluminium and copper current collectors, and to remove surface oxide, but an oxide layer will reform while the battery or supercapacitor is in use, and as a result, the ESR will progressively increase with such use. It should also be noted that chemical etching, to increase a collector's surface area, also involves use of strong acids, which are generally not suitable for printable battery or supercapacitor fabrication.

### SUMMARY

Various aspects of examples of the invention are set out in the claims.

According to a first aspect of the present invention, an apparatus is provided comprising first and second electrodes, first and second current collectors, an electrolyte, and a first contact layer; wherein the electrolyte is configured to separate the first and second electrodes; and wherein the first contact layer is configured to form an electrical contact between the first current collector and the first electrode.

According to a second aspect of the present invention, a method comprising: depositing a first contact layer on a first current collector; depositing a first electrode on the first contact layer; depositing a second electrode above a second current collector; and disposing an electrolyte between the first and second electrodes to form an apparatus comprising the first and second electrodes separated by the electrolyte; wherein the first contact layer is configured to make electrical contact between the first current collector and the first electrode.

### BRIEF DESCRIPTION OF THE DRAWINGS

For a more complete understanding of example embodiments of the present invention, reference is now made to the following descriptions taken in connection with the accompanying drawings in which:

FIG. 1 shows an apparatus according to one aspect of the invention;

FIG. 2 shows an apparatus according to another aspect of the invention;

FIG. 3 is a flow diagram showing operations for fabricating an apparatus according to one aspect of the invention; and

FIG. 4 show experimental results for an apparatus according to the invention.

### DETAILED DESCRIPTION OF THE DRAWINGS

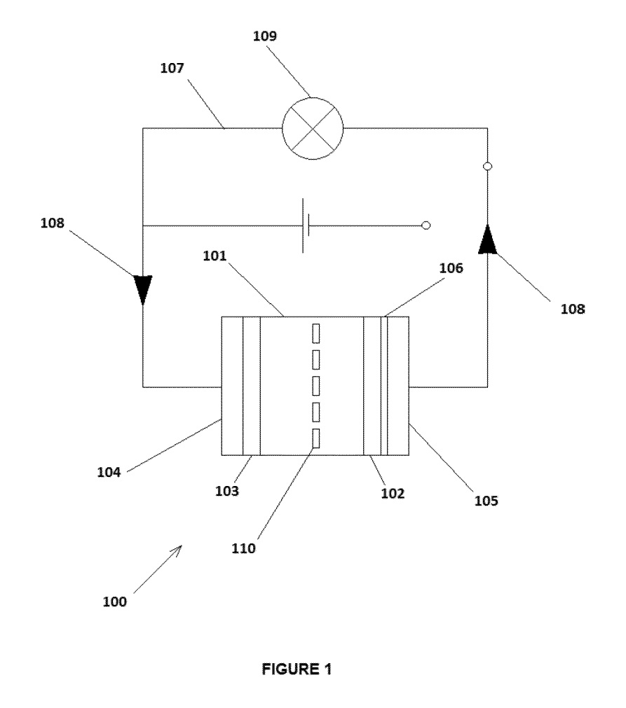

An example embodiment of the present invention and its potential advantages are understood by referring to FIGS. 1 to 4 of the drawings.

FIG. 1 shows an apparatus according to the invention that, in a first example, is a battery 100. The battery 100 comprises a first electrode 102, second electrode 103, separated by an electrolyte 101. The battery 100 also comprises a first current collector 104, and a second current collector 105; the first and second current collectors 104, 105 support the first and second electrodes 102, 103, and provide an electrical connection between the battery 100 and the external circuit 107. The battery 100 also comprises a separator 110 to prevent direct contact between the first and second electrodes 102, 103.

At the first electrode 102, (the anode of the battery 100), an oxidation reaction can take place which produces electrons. These electrons can flow round an external circuit 107 (indicated by the arrows 108) from the first electrode 102 (the anode of the battery 100) to the second electrode 103 (the cathode of the battery 100) causing a reduction reaction to take place at the cathode 103.

The flow of electrons 108 can be used to power one or more electrical components 109 in the external circuit 105. The oxidation and reduction reactions may continue until the reactants are completely converted. Unless electrons are able to flow from the anode 102 to the cathode 103 via the external circuit 107, the electrochemical reactions cannot take place. In the absence of the external circuit 107 to connect the anode 102, to the cathode 103, inhibition of the chemical reaction allows the battery 100 to store electricity for a considerable period of time. As the electrons flow round the external circuit 107 from the anode 102 to the cathode 103, a negative charge cloud develops in the electrolyte 101 around the cathode 103, and a positive charge cloud develops in the electrolyte 101 around the anode 102. Positive and negative ions (not shown in the diagram) in the electrolyte 101 move to neutralize these charge clouds, allowing the reactions, and the flow of electrons, to continue. Without the ions from the electrolyte 101, the charge clouds around each electrode 102, 103 would inhibit the generation of electricity. Power delivery to the electrical component 109, depends largely on the equivalent series resistance (ESR) of the battery 100. The interfacial resistance between the first electrode 102 and the first current collector contributes a significant part of the overall ESR. The invention provides a contact layer 106 between, and in electrical contact with, both the first electrode 102 and the first collector 105, to reduce the interfacial resistance between the first electrode 102 and first collector 105.

In one example, the battery 100 may be a lithium-ion battery, for which the electrolyte 101 comprises lithium ions (not shown in FIG. 1) that intercalate into and out of the first and second electrodes 102, 103 during charging or discharging of the battery 100. Such a lithium-ion battery 100, may comprise a carbon anode 102, such as graphite, the cathode 103 may comprise a lithium metal oxide, the cathode current collector 104 may comprise aluminum foil and the anode current collector 105 may comprise copper foil, and the electrolyte 101 may comprise a lithium salt and an organic solvent. The contact layer 106, may comprises a multiplicity of copper, silver or gold particles, the mean particle size being between 0.1 and 10 microns, and the contact layer 106 has mean thickness between 10 and 20 microns. The lithium metal oxide, from which the cathode is formed, may comprise one or more of: lithium cobalt oxide, lithium iron phosphate, and a spinel, such as lithium manganese oxide. The electrolyte may comprise a mixture of organic carbonates such as ethylene carbonate or diethyl carbonate. The lithium salts may comprise one or more of: lithium hexafluorophosphate (LiPF.sub.6), lithium hexafluoroarsenate monohydrate (LiAsF.sub.6), lithium perchlorate (LiC10.sub.4), lithium tetrafluoroborate (LiBF.sub.4), and lithium triflate (LiCF.sub.3SO.sub.3).

In contrast to batteries, capacitors store charge electrostatically. A relatively new type of capacitor known as a “supercapacitor” (also known as an electric double layer capacitor, an ultracapacitor, and an electrochemical double layer capacitor) offers greater energy storage than a conventional or electrolytic capacitor, and is becoming increasingly popular for portable electronic applications.

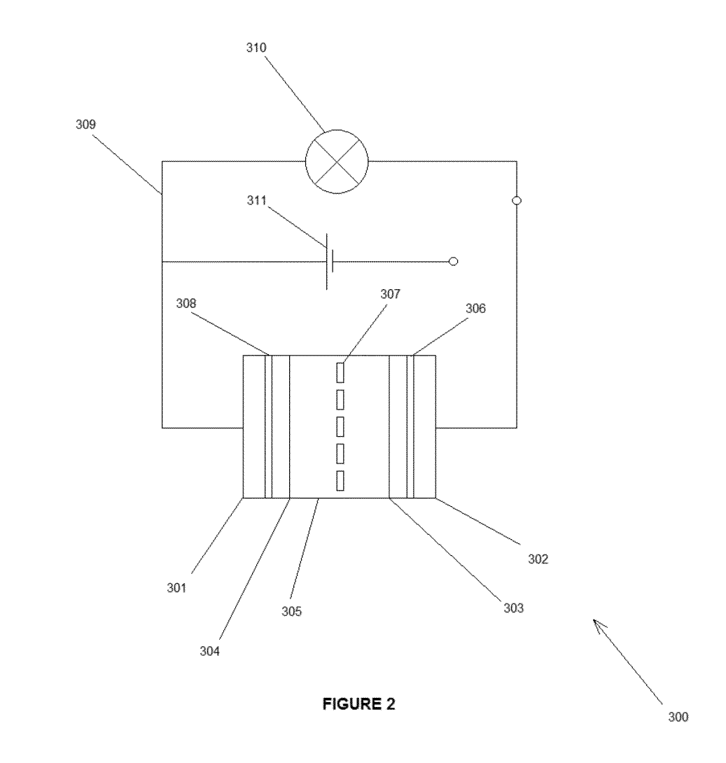

FIG. 2 illustrates schematically an apparatus according to the invention, which in this example is a supercapacitor 300. The supercapacitor 300 comprises first and second aluminium collectors 301, 302, together with first and second electrodes 303, 304. The first and second electrodes 303, 304 may comprise a porous carbon layer, since electrode porosity increases the electrode surface area in contact with the electrolyte 305, which results in greater charge storage. When a power supply 311 applies a potential difference between the first and second electrodes 303, 304, the electrolyte 305 becomes polarized. The potential on the first electrode 303 attracts positive ions in the electrolyte 305, and the potential on the second electrode 304 attracts negative ions. While the capacitor is being charged, ions in the electrolyte 305 arrange themselves at the surfaces of the electrodes 304, 303 to minor the surface charge 316 and form an insulating “electric double layer”. The combination of the electric double layer and the use of a high surface area material on the surface of the first and second electrodes 303, 304 allow charge carriers to be stored at the electrode-electrolyte interface.

As for the battery 100, shown in FIG. 1, power delivery to the electrical component 310, shown in FIG. 2, depends largely on the equivalent series resistance (ESR) of the supercapacitor 300. The interfacial resistance between the electrodes 303, 304 and the current collectors 301,302 contributes a significant part of the overall ESR. The invention provides a first contact layer 306 between, and in electrical contact with, the first electrode 303 and the first collector 302, to reduce the interfacial resistance between the first electrode 303 and first collector 302. The invention also provides a second contact layer 308 between, and in electrical contact with, the second electrode 304 and the second collector 301, to reduce the interfacial resistance between the second electrode 304 and second collector 301. The first and second contact layers 306, 308 may comprise a multiplicity of copper, silver or gold particles, the mean particle size being between 0.1 and 10 microns, and the contact layer 306, 308 has mean thickness between 10 and 20 microns.

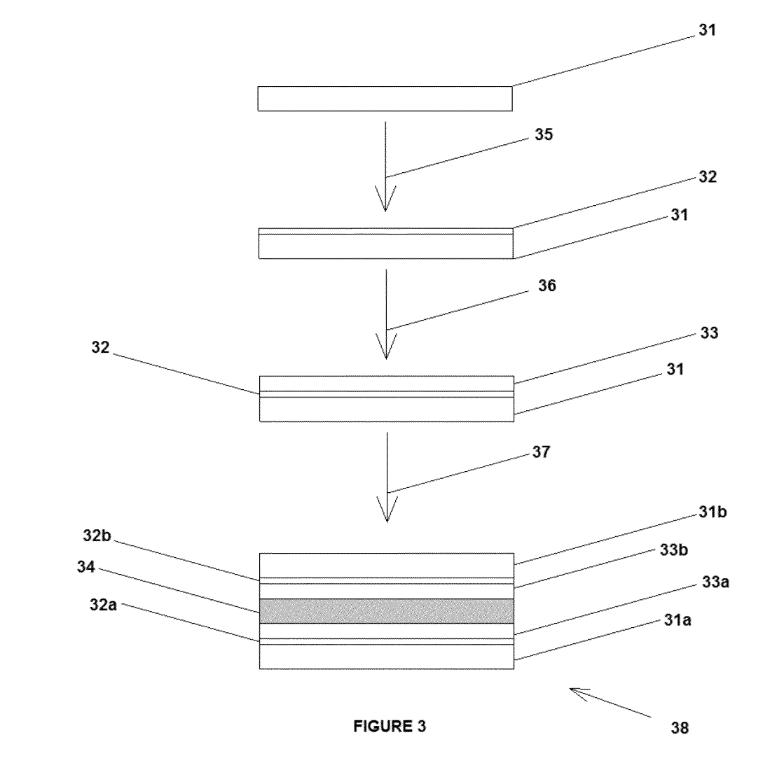

An apparatus 38 according to the invention may be fabricated by an overall process shown schematically in FIG. 3. A current collector 31 is processed in a first step 35 to deposit a contact layer 32 by printing a metal ink on the current collector 31. For a battery, the current collector 31 may be cathode current collector 31a, and may comprise copper foil, or the current collector 31 may be an anode current collector 31b, and may comprise aluminium foil. For a supercapacitor, both current collectors 31 may comprise aluminium foil. The metal ink may be deposited by one or more of: bar-coating, screen printing, gravure printing, flexo printing, and inkjet printing. The metal ink may comprise metal nanoparticles, the metal selected from one or more of: copper, silver, platinum or gold. The first step 35 may comprise drying, after the ink deposition, in a nitrogen filled oven, for 1 hour at 100° C. For both the aluminium and copper current collectors, the first step 35 may also comprise etching the foils to remove an oxide layer before printing the metal ink. If a silver ink is used then it may comprise micron-size Ag flakes at 65 wt % solid loading in dimethyl succinate. If a copper ink is used then it may comprise copper flakes at 60-90 wt % concentration in 1-(2-butoxyethoxy)ethanol.

In a second step 36 an electrode 33 is deposited on the contact layer 32, already deposited by first step 35. If the electrode 33 is an anode 33b of a battery, the electrode 33 is deposited in the form of a graphite ink, which has been prepared by mixing graphite powder, 10% carbon black and 5% binder in water or organic solvent. If the electrode 33 is a cathode 33a of a battery, then the electrode 33 is deposited in the form of a lithium metal oxide ink comprising lithium metal oxide (for example: LiCoO₂, LiMnO₄, or LiFePO₄) and 5% binder in organic solution. If the electrode 33 is one of the electrodes of a supercapacitor, then the electrode 33 is deposited in the form of activated carbon ink, comprising activated carbon powder and 5% binder in water. The ink is bar-coated onto the contact layer 32, which is supported by the current collector 31, and then dried at 100° C. for 1 hour.

In a third step 37 a separator 34 is soaked in electrolyte and sandwiched between electrodes 33a and 33b. to yield an apparatus 38. If the apparatus 38 is a battery, then the electrolyte 34 comprises 1 M lithium hexafluorophosphate (LiPF6) in proplycarbonate. If the device is a supercapacitor, then the electrolyte 34 comprises 1.25 M tetraethylammonium tetrafluoroborate (TEABF₄) in propylene carbonate.

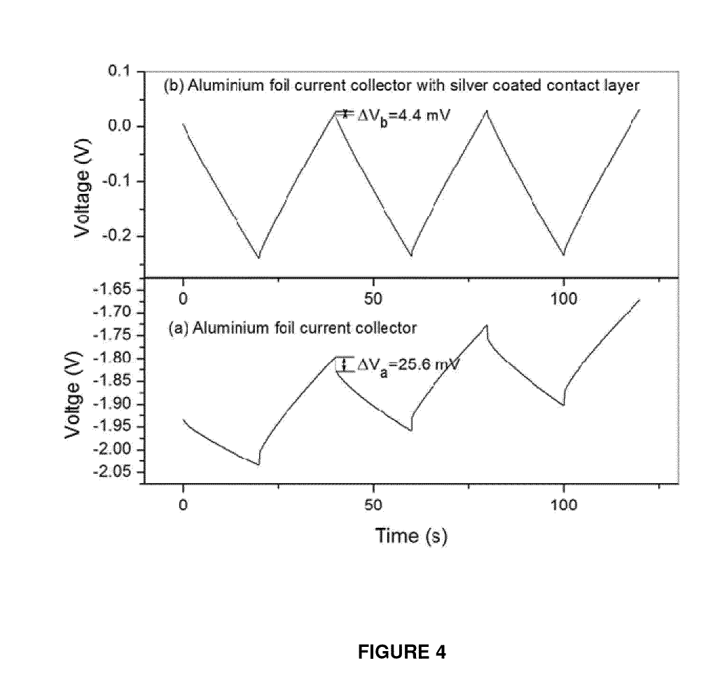

FIG. 4a shows charge and discharge curves for a supercapacitor that has an aluminium current collector with no contact layer, and FIG. 4b shows charge and discharge curves for a supercapacitor, substantially identical to the FIG. 4a device save that it has a silver contact layer. Both FIGS. 4a and 4b show the potential difference across the supercapacitor as a function of time, for FIG. 4a, a potential drop, ΔVa, of 25.6 mV is observed, whereas the potential drop, ΔVb, for the FIG. 4b device is 4.4 mV. This change reflects a decrease in resistance, from 12.8 to 2.2Ω, due to the presence of the silver contact layer.

Without in any way limiting the scope, interpretation, or application of the claims appearing below, a technical effect of one or more of the example embodiments disclosed herein is to reduce the ESR of a supercapacitor or a battery. Because an apparatus according to the invention comprises a thin contact layer comprising metal nanoparticles, another technical effect of one or more of the example embodiments disclosed herein is that the battery or supercapacitor may be fabricated by commonly available printing techniques.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus comprising first and second electrodes, first and second current collectors, an electrolyte, and a first contact layer; wherein the electrolyte is configured to separate the first and second electrodes; and wherein the first contact layer is configured to form an electrical contact between the first current collector and the first electrode.

2. An apparatus according to claim 1 wherein the apparatus comprises a second contact layer, and wherein the second contact layer is configured to form an electrical contact between the second electrode and second current collector.

3. The apparatus of claim 1, wherein one or both of the first and second electrodes comprise at least one of: activated carbon, graphene, graphene platelets, a silver nanowire mesh, silicon nanowires, carbon nanotubes, and a metal oxide.

4. The apparatus of claim 1, wherein the electrolyte comprises a polymer electrolyte.

5. The apparatus of claim 1 wherein at least one of the first and second the current collectors comprise aluminum, or copper.

6. The apparatus of claim 1 wherein the first contact layer comprises one or more of copper, silver, gold, and platinum.

7. The apparatus of claim 1 wherein the first contact layer comprises a multiplicity of particles, the mean particle size being between 0.1 and 10 microns.

8. The apparatus of claim 1 wherein the first contact layer has a mean thickness between 10 and 20 microns.

9. The apparatus of claim 1, wherein the apparatus is a battery, a supercapacitor, or a battery-capacitor hybrid.

10. A device comprising the apparatus of claim 1.

11. The device of claim 10, wherein the device is at least one of the following: an electronic device, a portable electronic device, a portable telecommunications device, and a module for any of the aforementioned devices.

12. A method comprising: depositing a first contact layer on a first current collector; depositing a first electrode on the first contact layer; depositing a second electrode above a second current collector; and disposing an electrolyte between the first and second electrodes to form an apparatus comprising the first and second electrodes separated by the electrolyte; wherein the first contact layer is configured to make electrical contact between the first current collector and the first electrode.

13. A method according to claim 12 wherein depositing the second electrode above the second current collector comprises depositing the second electrode on the second current collector.

14. A method according to claim 12 wherein the method further comprises depositing a second contact layer on the second current collector, and wherein depositing the second electrode above the second current collector comprises depositing the second electrode on the second contact layer, which has been deposited on the second current collector.
